(19) United States
(12) Patent Application Publication
(10) Pub. No.: US 2024/0303437 A1
(43) Pub. Date: Sep. 12, 2024

(54) SYSTEMS AND METHODS FOR IMPLEMENTING AN ADVANCED CONTENT INTELLIGENCE PLATFORM

(71) Applicants: Peter Robert KRAUS, Virginia Beach, VA (US); Jurgen KRANZ, Waldbrol (DE); Michael Kurt Fell, Tuttlingen (DE); Paul Heinrich Janecki, Cologne (DE); Goksu Heinrich Keskin, Bergisch Gladbach (DE); Rida Tariq Salam, Gera (DE); Simon Matthias Scholl, Bergisch Gladbach (DE); Friederike Scholz, Bautzen (DE); Tim Siebigteroth, Cologne (DE); Volodymyr Deviatkin, Barcelona (ES)

(72) Inventors: Peter Robert KRAUS, Virginia Beach, VA (US); Jurgen KRANZ, Waldbrol (DE); Michael Kurt Fell, Tuttlingen (DE); Paul Heinrich Janecki, Cologne (DE); Goksu Heinrich Keskin, Bergisch Gladbach (DE); Rida Tariq Salam, Gera (DE); Simon Matthias Scholl, Bergisch Gladbach (DE); Friederike Scholz, Bautzen (DE); Tim Siebigteroth, Cologne (DE); Volodymyr Deviatkin, Barcelona (ES)

(21) Appl. No.: 18/602,006

(22) Filed: Mar. 11, 2024

Related U.S. Application Data
(60) Provisional application No. 63/451,096, filed on Mar. 9, 2023.

(51) Int. Cl. G06F 40/289

(52) U.S. Cl. CPC G06F 40/289

(57) ABSTRACT

The disclosed systems, methods, schemes, techniques and processes implement an advanced content intelligence platform in a manner that creates predictably high performing content to meet a the objectives of users and enterprises by combining human intelligence with deep machine learning to determine a full body of content relevant to the objectives of a user or enterprise regarding a content output involving the steps of applying content intelligence to perform a deep dive into the information available on a specific topic, and to determine which of the available content may be particularly adapted to achieving the objectives of the user or enterprise in delivering optimized output content.

### BACKGROUND

This application claims the benefit of U.S. Provisional Patent Application No. 63/451,096, entitled “First Content Intelligence Platform,” filed in the U.S. Patent and Trademark Office (USPTO) on Mar. 9, 2023, the disclosure of which is hereby incorporated by reference herein in its entirety.

### 1. FIELD OF THE DISCLOSED EMBODIMENTS

The disclosed embodiments provide systems, methods, schemes, techniques and processes for implementing an advanced content intelligence platform in a manner that creates predictably high performing output content to meet a the objectives of users and enterprises by combining human intelligence with deep machine learning (ML) to determine a full body of content relevant to the objectives of a user or enterprise regarding a content output involving the steps of applying content intelligence to perform a deep dive into the information available on a specific topic, and to determine which of the available content may be particularly adapted to achieving the objectives of the user or enterprise in delivering output content.

### 2. RELATED ART

The last several decades have seen a ubiquitous proliferation in the amount of information available to users on virtually any topic. Based on the flood of information available, it is beyond comprehension, or the limitations of human intelligence, that a particular user may prove capable of reviewing, much less assimilating “all” of the available data that may be pertinent to specified objectives of a particular user or enterprise, with regard, for example, to generating output content in a particular field of the user or enterprise. This shortfall in an ability of any individual user, or even an extensive enterprise, to review and assimilate mounds of available information and data content has led many individual users and enterprises to find schemes by which to parse the workload, or expand collaboration, with teams particularly directed to searching “all” available sources find “all” relevant information associated with a particular topic or enterprise objective.

The hit-and-miss nature and capacity of such human-driven content search and delivery methodologies proved, at once, fraught with error, and unable to keep pace with the wildly expanding volume of available pertinent data, and information content, to be searched. The understood shortfalls in these capabilities were among the motivations to find innovative approaches by which to apply advancing technological solutions to schemes for providing detailed and accurate content delivery to meet the particular objectives of an individual or enterprise.

Thus has emerged a family of technologies, and technology-based solutions, commonly referred to under an umbrella label as “artificial intelligence” or “AI,” and an application of AI-based solutions to information search and content delivery. As will be discussed in greater detail below, these AI based methodologies often do not specifically address the output content delivery objectives of a particular user or enterprise for myriad reasons. According to emerging technologies, the “possibilities” for addressing individual information search and content delivery scheme shortfalls may seem, at first blush, ever expanding and virtually endless. ML and AI, even in their current forms, can prove extremely useful in the process of information and data search, but do not necessarily address the specific content delivery objectives of any individual or enterprise. It is well understood that the potential exists for AI to generate amazing content for unique enterprise endeavors. In this regard, ML and AI may be considered efficient copilots when properly applied to the objectives of a particular user or enterprise.

So prolific are these concepts, even at this comparatively early stage in their development and exploitation, that a number of publicly available and/or commercial capabilities have emerged and been fielded for employment. Individual user and enterprise search strategies are now being facilitated by these emerging technologies to an extent that could not have been envisioned even just a couple of years ago. This is not to imply, however, that any of the individually fielded search tools, even those including increasing levels of ML and AI, are not without their challenges. One problem is that 90% of the published content may be generally irrelevant, and certainly irrelevant to a particular user, enterprise or endeavor, even with Generative AI helping teams produce more content at a faster rate. Contemporary studies predict that by 2026, for example, 80% of creative teams will be tasked with seeking targeted or differentiated results from AI, increasing among other metrics a cost of expert talent to parse search results to make them effectively practical to a user or enterprise.

Other identified challenges that may be particularly applicable to businesses applying current and advancing ML and AI tools include, but are not limited:
Factual Errors: Data can occasionally be completely wrong, putting brand safety of a particular enterprise at risk.
Model Limitations: Responses may be, for example, based on overly-broad data sets at a given point in time and may not incorporate, for example, current trends or specific (targeted) industry insights.
Attribution: Relevant references and attributions, which may not be readily available (if at all), may be required for domain authority and trust.
Detectable by Certain Search Platforms: Businesses risk may be, for example, penalized by certain search platforms in instances in which those search platforms may rely upon certain AI products too heavily, or even exclusively.
Search Engine Optimization (SEO) Gaps: AI products may not follow SEO best practices, e.g., limiting the likelihood of ranking well.
Lack of Authenticity: For ultimate content delivery, output writing may lack originality (may be considered plagiarized) because the output writing may be principally, or exclusively, based on prior written content.

### SUMMARY OF THE DISCLOSED EMBODIMENTS

In view of the clear need, and easily identifiable shortfalls in currently-available systems, methods, schemes, techniques and processes for content delivery according to the objectives of individual users and/or enterprises, it would be advantageous to provide an advanced content delivery and data management system particularly tailored to overcoming these shortfalls and to better adapting the tremendous advances that may be realized from implementation of AI and deep ML to rendering output content products to meet the content delivery objectives of particular users and enterprises.

What is needed is for AI to generate content strategies to meet that demand and make the most of current and emerging large generative AI models. Put another way, given the tremendous increases in the capabilities that may be realized from adaptation of AI and ML, along with the ongoing avalanche of available data content, it may be particularly beneficial to tailor and adapt current AI and ML methodologies to produce better output content by proposing systems, methods, schemes, techniques and processes for output content delivery that may realize an achievable increase in one or more of the following content delivery metrics:
Speed: In embodiments, collaborative AI workflow according to this disclosure may improve efficiency while keeping the “writer” in control of the content generation and delivery process.
Authority: In embodiments, a premium may be placed on ensuring clear references and authoritative links being provided to establish and ensure the highest levels of provenance as may be increasingly required in all output content delivery.
Originality: In embodiments, the disclosed collaborative process may increase authenticity in the writing with real authors thereby avoiding, for example, search service penalties and accusations of plagiarized content.
SEO Best Practices: In embodiments, the disclosed schemes may particularly incorporate current, and evolving, SEO best practices in, for example, the collaborative environment execution guidance as it is implemented and updated to improve ranking and content performance.
Brand Safety: In embodiments, the disclosed systems and processes may provide enterprises with additional level of trust in the output products as being based on the best available facts, associated industry data and current and projected industry trends.

Exemplary embodiments of the systems, methods, schemes, techniques and processes according to this disclosure may provide a more effective generative AI solution for output content delivery over those currently available by targeting and optimizing a series of principal metrics including
Implementing a robust ML strategy based on models customized to the objectives for output content delivery provided by an individual, a business or another enterprise;
Providing a complete workflow for a collaborative process to ensure “safe” use of generative AI; and
Focusing on data driven performance, which may be best realized in a business implementation scenario, for example, by better leveraging own company and competitor company data to its fullest extent to generate optimal output content for the current business field.

Exemplary embodiments may depart from the conventional industry solution that generally, typically and inefficiently aggregates many separate and disparate available services to attempt to optimize a patchwork of content delivery schemes, by providing a single platform for integrating the tasks of exploring, planning, briefing, creating, publishing, and monitoring the generation and delivery of output content, and use of content products according to the objectives of individual users or enterprises.

Exemplary embodiments may effectively address certain (a) observations regarding the shortfalls in currently-fielded AI solutions and (b) industry predictions regarding the anticipated reach of AI-augmented operations across a variety of enterprises.

Exemplary embodiments may provide enterprises with a mechanism by which to most efficiently and effectively employ AI, for example, across marketing functions to accelerate the coming transition from day-to-day operational production activities to forward-looking strategic activities.

Exemplary embodiments may apply customized ML schemes to read more content, including web pages; create relevant topic maps; correctly interpret, apply and understand context of keywords; ascertain and exploit the relevance of search terms; and leverage all the best practices and implementations of available search algorithms and rules.

Exemplary embodiments may combine human insight and deep ML intelligence in order to determine “what to write about” in presenting the output content according to the objectives of the individual or enterprise. Exemplary embodiments may initially determine “what to write about” by obtaining detailed content intelligence from the individual or enterprise, reviewing currently-available deep ML and natural language understanding (NLU) solutions and determining applicability in the generation of a custom search model to most effectively address the objectives of the individual or enterprise. The above-indicated detailed content intelligence from the individual or enterprise may include a full understanding of a business of the individual or enterprise, an overall market within which the business operates, and an outline/overview of competing individuals or enterprises in the business/market.

Based on the above inputs, exemplary embodiments of the disclosed platform may develop an overall search strategy for locating and interpreting substantially all relevant available data in a manner that no human, group of humans or even conventional machine-implemented search strategy may achieve. The focus of the enterprise-specific content model may be directed at evaluating available content for specific relevance to the objectives of the individual or enterprise in a manner that may easily allow the model to limit the collected information to only that considered most relevant, while discarding the balance, so as not to be overwhelmed.

Armed with the most relevant data to the enterprise, including that most advantageous to one's competitors, embodiments of the disclosed systems may then advance to implementing a content creation workbench that may advantageously or optimally aggregate deep ML and natural language generation (NLG) schemes and general models of output content to “go write” or generate the particular output content product for delivery to meet the objectives of the individual or enterprise.

These and other features, and advantages, of the disclosed systems, methods, schemes, techniques and processes are described in, or apparent from, the following detailed description of various exemplary embodiments.

### BRIEF DESCRIPTION OF THE DRAWINGS

Various exemplary embodiments of the disclosed systems, methods, schemes, techniques and processes for providing an advanced content delivery and data management system, particularly tailored to overcoming the known shortfalls in conventional systems set forth above, and to better adapting advances that may be realized from implementation of AI and deep ML to rendering output content products, according to this disclosure, will be described, in detail, with reference to the following drawings, in which:

FIG. 1 schematically illustrates a simple block diagram of an exemplary process flow for implementing an advanced content search, generation, delivery and data management platform according to this disclosure;

FIG. 2 schematically illustrates a block diagram of an exemplary process for an enhanced process for topic and keyword extraction from textual data that may be implemented within an exemplary system for implementing a secure and content-controlled data exchange scheme according to this disclosure;

FIG. 3 schematically illustrates a block diagram of an exemplary process for a strategic content optimization system through topic and keyword analysis that may be implemented within an exemplary system for implementing a secure and content-controlled data exchange scheme according to this disclosure;

FIG. 4 schematically illustrates a block diagram of an exemplary process for topic opportunity ideation that may be implemented within an exemplary system for implementing a secure and content-controlled data exchange scheme according to this disclosure;

FIG. 5 schematically illustrates a block diagram of an exemplary overview of a process for article optimization that may be implemented within an exemplary system for implementing a secure and content-controlled data exchange scheme according to this disclosure;

FIG. 6 schematically illustrates a block diagram of elements that may be considered in an exemplary process for assigning a score that evaluates a probability of high visibility for an article and that supports a user in optimization that may be implemented within an exemplary system for implementing a secure and content-controlled data exchange scheme according to this disclosure; and

FIG. 7 schematically illustrates a block diagram of an exemplary system for implementing an advanced content search, generation, delivery and data management platform according to this disclosure.

### DETAILED DESCRIPTION OF EMBODIMENTS

Embodiment of the disclosed systems, methods, schemes, techniques and processes are intended to provide targeted content delivery according to the objectives of individual users and/or enterprises, through an advanced content delivery and data management system particularly tailored to overcoming identified shortfalls in conventional systems and methods by better adapting the tremendous advances that may be realized from implementation of AI and deep ML to rendering output content products meeting the objectives of individual users or enterprises.

Exemplary embodiments according to this disclosure may automatically generate hyper-accurate subject matter expert AI models from relevant market data to identify best topics and strategies to engage the specific audience to which an enterprise seeks to direct its targeted content delivery. Whether launching a new product or service or refreshing web content to amplify interest and engagement, exemplary embodiments according to this disclosure may implement a process for developing and delivering such targeted content according to objectives specified by the enterprise. Exemplary embodiments may field AI-generated strategies to improve enterprise results attributable to their content delivery. Exemplary embodiments may improve the delivery of relevant content, through a reliable approach to Generative AI, and quick time to value compared to custom Large Language Model (LLM) training.

To meet current targeted enterprise demands, exemplary embodiments may provide AI-generated content strategy that goes beyond current large Generative AI models with their homogenized data pools of subject matter and topic generation that in turn produce, at best, generic copy that goes nowhere and does nothing to drive engagement in an increasing flood of the same, even assuming that all of the content is accurate.

Exemplary embodiments may automatically generate hyper-accurate subject matter expert AIs from relevant market data to create engaging and compelling content strategies for precisely the audience that an enterprise desires, or otherwise may need, to target.

Embodiments of the disclosed systems are adaptable such that an enterprise-specific (theme-specific) deep ML model according to objectives, themes, or topics of the enterprise may be developed to search the body of available content using updated NLU and then to incorporate a task of generating enterprise-requested output content through NLG in a manner that captures the content delivery objectives of the enterprise.

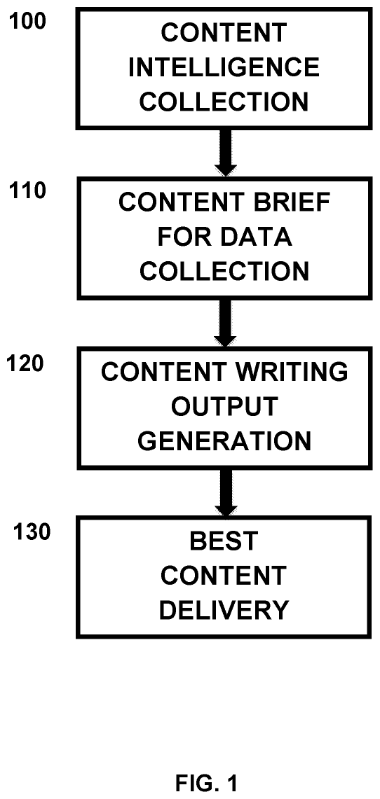

FIG. 1 schematically illustrates a simple block diagram of an exemplary process flow for implementing an advanced content search, generation, delivery and data management platform according to this disclosure. In embodiments, a first step 100 in the process may be to collect content intelligence. The content intelligence may be most appropriately collected from the enterprise regarding, for example, what the enterprise may ultimately want the output content delivery to entail. Additionally, content intelligence may include, but not be limited to, observations of the enterprise on the business sector within which the enterprise operates, a broader initial evaluation of the marketplace encompassing the business sector within which the enterprise operates, and an enterprise-generated listing of known competitors of the enterprise within the business sector and within the marketplace. In embodiments, although not required, the enterprise may provide the enterprise's own list of selected keywords as a basic premise from which a content brief may be formulated.

In a second step 110 in the process, a brief for content data collection using deep ML and NLU may be formulated. Such a brief may be considered to form a road map for the data collection process undertaken through a collaborative AI process including, for example, an evaluation of the structure of the content to be reviewed, and a series of content vectors that may be employed to conduct the review of the content. Each of the content vectors may be associated with a particular keyword or key term, either of which may be content specific, by which the platform itself may evaluate the “best” directions for the review of the content to progress. It is contemplated that such a brief may contain literally hundreds of vectors.

In a third step 120 in the process, the writing phase may be undertaken. Particularly relevant content that addresses the objectives of the enterprise within the business and marketplace, may be assembled, and using NLG, may be “written” into a product that is substantially a draft of the generated output.

In a fourth step 130 in the process, an ultimate output content delivery product may be washed through a process of evaluation and re-evaluation to ensure that the finished content product represents a “best” content product for delivery according to the output delivery objective of the enterprise.

In embodiments, it should be noted that any of the enumerated steps, or any, for example, sub-steps encompassed by any one of the enumerated steps, may be undertaken manually, may be fully automated, or may be undertaken at any point on a technological scale between manual and fully automated implementation. In embodiments, depending on the step or sub-step, the particular step or sub-step may be undertaken through a hybrid manual/automated process, as appropriate. While no limitations regarding the manual or automated implementation of any step or sub-step is to be implied by the above discussion, it should be recognized that a move toward full automation of all of the relevant steps, and/or sub-steps, may be desired by the enterprise to increase the efficiency, or maybe required based on the scope of the content that requires evaluation in order to meet the output content delivery objectives of the enterprise.

In embodiments, examples of hybrid steps in the process may include requiring a manual entry of certain prompts in the second (brief) step 110, or particular reference to available NLG resources in the third (write) step 120.

With regard to selection of the prompts, a correct formula for undertaking the second (brief) step 110 may involve creating a particular formula and then putting into that formula the right input parameters. As an example of this, the formula may include a prompt to “write a long form article on a particular subject given particular keywords.” The parameters then to be input into this formula may include the “particular subject” and at least the initial “keywords.” In this manner, in the second (brief) step 110, the platform may then generate particular vectors based on the correct formula that generates the prompt. Put another way, the platform may define the input parameters for the formula. Different prompt formulas, and forms of such prompt formulas, it should be recognized, may be applicable to different use cases. The platform may provide guidance in determining the applicable formula, and in populating that determined formula with the initial keywords.

In embodiments, in the third (write) step 120, fine tuning of the NLG may be undertaken by the platform in order to “write” higher quality output based on various parameters, including, but not limited to, both of content itself, and a “tone” of the voice in the output content. Content and tone selection may be undertaken by the platform using deep ML, for example, to train the NLG. It should be recognized that every NLG model may have endemic strengths and weaknesses. The platform may be configured in such a manner that it will necessarily use only the recognized strengths in the chosen NLG model. In embodiments, the more models that the platform has to draw upon, the better and more valuable this selection process may be.

In embodiments, a text input may be provided to the platform and may be interpreted using NLU. Once the second (brief) step 110 of the disclosed process is completed, the third and fourth steps 120, 130, may ultimately be completed using the preferred (or selected) NLG model, as outlined above.

It is known that artificial neural networks, of which this platform may generically be considered to consist, may be “trained” in a manner similar to the training and/or education of the human brain. The second (brief) step 110 may capitalize upon this understanding as it develops content vectors by recognizing, for example, a semantic proximity of topics to keywords and selected terms. In this regard, the inputs for the formula described above may grow from the initial keywords input to the formula in a manner that the deep ML may collect and iterate content vectors through a process of topic model learning that may entail finding the semantic proximity of articles and/or topics, and creating meaningful topic hierarchies to be followed as relevant content is identified and sorted.

In embodiments, custom inputs may be defined according to the objectives of the enterprise, and the brief designed by automatically, or semi-automatically, applying the above known vector definition methods in the disclosed process.

In embodiments, custom outputs may be made available for review, for example, by allowing the chosen NLG model to produce alternative top-level, or “headline,” outputs for review by the platform, or in an interim sub-step, by the enterprise.

In embodiments, the custom output may stop short here, short of the actual production of the complete output content delivery, and simply provide the enterprise, or a separate human writer, with the alternative headline(s) and select data content determined through execution of the brief to facilitate the manual writing of the output delivery content. The manual writing process, facilitated by the above-described mechanics of the brief step, may facilitate the content and tone of the output delivery product being under the sole purview of the enterprise or the writer. In embodiments, the custom output may continue to the actual production of the complete output content delivery for the enterprise, e.g., with one push of a button and all the input from the brief, the platform may generate the full article, making selection of the NLG model in the manner discussed above important to control the content and tone of the output content delivery product according to the desires of the enterprise.

Exemplary embodiments may provide an enhanced process for extracting relevant topics and keywords from extensive textual corpora. In embodiments, the disclosed platform may integrate a unique combination of natural language processing (NLP) techniques and ML algorithms in a manner that has as at least one objective accurately identifying and extracting key topics and associated keywords. Embodiment of the disclosed process may prove distinctive in an ability to map relationships among the extracted topics and their associated keywords, providing a structured and semantic overview of the content within the corpus in fulfillment of the objectives specified by individual users or enterprises.

In embodiments, the disclosed system may be used to support text creation and enhancement, improving the coverage of relevant keywords and phrases of a topic as well as suggesting related topics. Extracted topic semantics may be used by human writers or other computer systems.

It is recognized that text messages, individually and in exchanges, may be defined by the topics to which the text messages are directed, and essential keywords and key phrases of which the text messages are composed. To increase informativeness presented by the large volume of text messaging, relevant keywords and key phrases, and closely related topics mentioned, may be used. Determining which keywords and phrases to select for a given text message, individually or as part of an exchange, and which topics to identify and isolate represents a complex task. In conventional text message review and analysis, it should be noted that important semantical aspects associated with individual text messages and text message exchanges may be overlooked, or otherwise missed, by an author.

This oversight by authors may have been seen to exist regardless of the conventional method employed for topic and/or keyword extraction from textual content. Conventional approaches, however, primarily employ forms of statistical measures and basic machine learning models, such as Term Frequency-Inverse Document Frequency (TF-IDF), Latent Semantic Analysis (LSA), and Latent Dirichlet Allocation (LDA), among others. Such methods have been instrumental in early text analysis tools and applications, ranging from search engine optimization to scholarly research. These conventional text message analysis methods tend to be limited by their use of what are colloquially referred to as Bag of Words (BoW) models. BoW models tend to ignore context and word order, which may detrimentally lead to loss of nuanced meanings in the extraction process for keywords and/or topics. These models generally (a) represent text statically, which does not account for the variable meanings of words in different situations, and (b) lack the dynamic, context-aware embeddings found in more advanced NLP models. The older conventional methods may not fully capture the semantic richness of language, making those models less effective for a complex task such as topic detection.

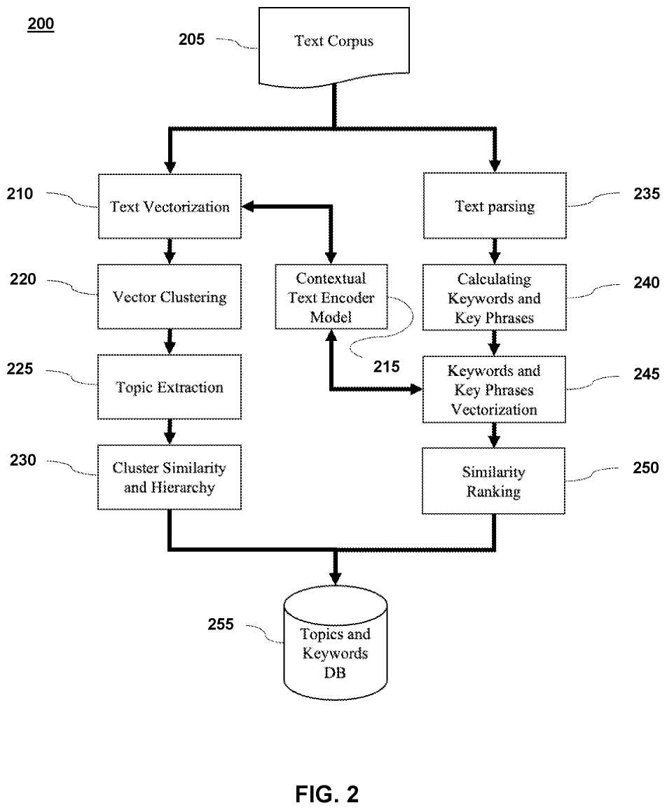

FIG. 2 schematically illustrates a block diagram 200 of an exemplary process for an enhanced process for topic and keyword extraction from textual data that may be implemented within an exemplary system for implementing a secure and content-controlled data exchange scheme according to this disclosure.

As shown in FIG. 2, exemplary embodiments of the disclosed process may leverage contextual text embeddings to offer a more accurate and adaptable approach to topic and keyword detection, addressing the shortcomings of traditional models.

To extract semantic information of a text corpus 205, contextual text vectors or “embeddings,” may be computed in a text vectorization step 210 using, for example, a machine learning contextual text encoder model 215. Through this process, the textual meaning may be encoded in a mathematically comparable representation. A collection of these vector may be assembled to provide mathematical representations of the text corpus 205 in a commonly understood representation of a semantic space. The process may perform vector clustering 220 within the semantic space to find groups of similar representations within the text corpus 205, forming a set of topic candidates of the texts. Then, in a topic extraction step 225, the process may compare the clusters found in the semantic vector space, defining cluster similarity (relationships overlap) and hierarchy 230. The process may target overlapping clusters by splitting the overlapping clusters into multiple clusters of possibly different topics. Conversely or separately, similar clusters may be unified into a single topic cluster. The resulting text clusters may define topics which exhibit characteristic keywords and phrases.

The process may compute, for each found topic, associated keywords and key phrases as follows. In a text parsing step 235, texts of the text corpus 205 may parsed using, for example, a language-specific grammar. From the parsed texts, keywords and key phrases (candidates) may be calculated (extracted) in step 240. Vector representations of the keywords and key phrases in step 245 may be computed using the same contextual text encoder model 215 as was used for the vectorization of full texts in step 210. This may aid in ensuring that the keyword and phrase vectors derived in step 245 are in the same semantic space as the text vectors derived in step 205 from raw texts, which may aid in making them efficiently comparable. In step 250, a similarity between extracted keywords and phrases and the semantic representations of the texts may be measured and a ranking may be assigned that may determine the phrases that are best representative of each text. Because each text may belong to exactly one dominant topic, the keywords and phrases of each topic may be defined as those keywords and phrases occurring in those texts that belong to the topic.

Finally, topic representations composed of the topics and their associated key phrases may be stored in a topic and keywords storage database 255. A user may later query the topics and keywords storage database 255 to obtain a structured view of the semantics of a topic along with its relevant keywords and phrases.

Exemplary embodiments may provide sophisticated processes designed to guide users in content strategy by discovering optimal topics and keywords from a specialized topics and keywords storage, as discussed above. Extensions of the above process may integrate semantic information from a domain of a user or user enterprise, and from such domain of competitors of a user or user enterprise, alongside metadata such as search volumes and rankings, to assist in selecting most impactful topics and keywords for creating content that drives organic interest and achieves high search engine rankings for the user or user enterprise.

Exemplary embodiments may aid in text creation and enhancement by leveraging topics and keywords storage complemented with search volume metadata. Such a process may support users and user enterprises in strategic selection of topics and keywords to optimize delivered content of the user or user enterprise for better visibility and higher ranking, for example, in web search results. Recommendations from such an exemplary process may be tailored to not only enhance relevance and informativeness of the delivered content, but also to give the user or user enterprise a competitive edge in the market based on the placement of the delivered content.

It is recognized that creating content that resonates with readers, and that ranks well on search engines, is a complex task. Content authors often struggle, for example, to determine which keywords and phrases to use and which topics to mention to best promote exposure to the audience that the authors are trying to reach. Additionally, achieving high rankings in web search engines may be influenced by the content's alignment with the most relevant topics and keywords in a particular domain. Embodiments of this process portion may address the challenge of selecting the most beneficial topics and keywords to maximize content engagement and search ranking potential.

Conventionally, content strategists and writers have manually researched topics and keywords, using basic tools to assess search volumes and rankings. Such an approach may not have proven effective in integrating a necessary, or overarching, comprehensive understanding of the content domain, and thus may have been ineffective in modeling the customer and competitor domain data, leading to decisions regarding content delivery that were less informed, and that potentially missed opportunities for higher content rankings to thereby reach a broader targeted audience. Manual and rudimentary, conventional methods were not only time-consuming and prone to human error, but also lacked a capability and capacity to model complex customer and competitor domain data accurately. Without precise, data-driven insights and an integrated methodology for combining semantic analysis with search data, content creators struggled to provide a holistic view of a market's content strategy, and often failed to adapt to the dynamic nature of web search trends and rankings, thus hindering reliable predictions as to the effect of the topic and keyword choices made in the preparation of output content for delivery.

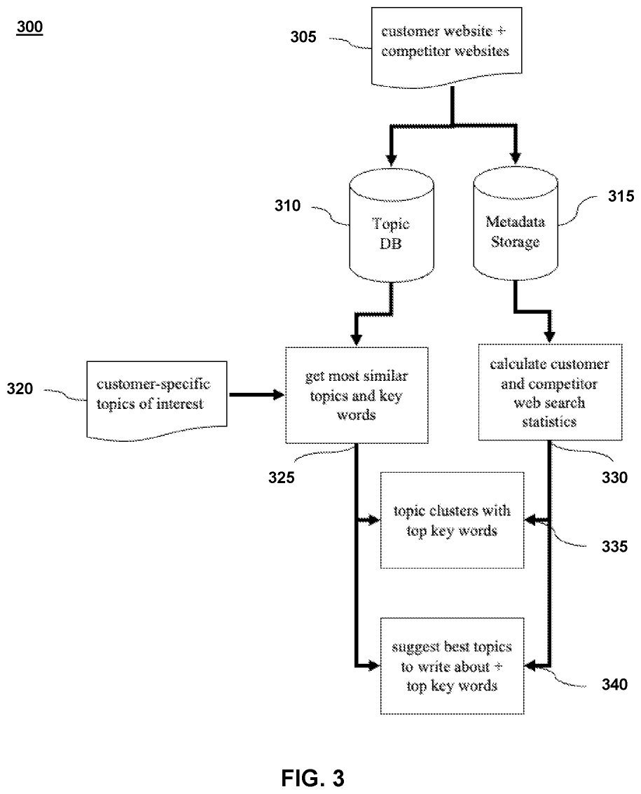

FIG. 3 schematically illustrates a block diagram 300 of an exemplary process for a strategic content optimization system through topic and keyword analysis that may be implemented within an exemplary system for implementing a secure and content-controlled data exchange scheme according to this disclosure.

Exemplary embodiments may streamline a process by automating identification and suggestion of topics and keywords, contextualized by customer and competitor domain data. In embodiments, the process may begin with the construction of a topic database (topic DB) 310 from a corpus of texts sourced from customer and competitor websites 305 in a manner similar to that outlined above (and as depicted in FIG. 2) to commence with the text corpus 205, executing the enhanced process for topic and keyword extraction from textual data, to arrive at topic representations composed of the topics and associated key phrases stored in a topic and keywords storage database 255. This topic DB 310 may be rich in semantic information from the perspective of both customers and competitors. Such a topic DB may provide an effective resource for customer market analysis in formulating delivery content.

To target an enhancement of web search rankings, embodiments of the process may accompany the topic DB 310 with a metadata storage 315 that may contain search ranking data for analyzed websites. In embodiments, the process may analyze stored data to calculate (compute) search statistics for both the customers and competitors in step 330, providing a data-driven foundation for decision making regarding targeting customers with content delivery. In embodiments, customers may input desired topics of interest in step 320. The customer-specific topics of interest, input in this step 320 separately from the information available in the corpus of texts sourced from customer and competitor websites 305, may differ from the topics and keywords stored in the topic DB 310.

In embodiments, step 325 of the process may then intelligently retrieve most similar topics and keywords from the topic DB 310 based on the customer-specific topics of interest input in step 320. Results may be synthesized with the web search statistics from step 330 to pinpoint the most pertinent and high-performing topic clusters, along with their top keywords at step 335. Additionally, the process may resultingly proactively suggest optimal topics and keywords in step 340, empowering users and user enterprises to create content that is not only relevant, but also competitively poised to rank well in web searches.

Exemplary embodiments may provide a capacity for topic ideation and opportunity assessment, based on topic understanding. In embodiments, a content research and monitoring process may be provided for use in marketing, especially in content marketing, for identifying relevant content with an objective, for example, of increasing defined key performance indicators (KPIs), e.g., sales, leads, downloads, and the like, of a company and its offerings, as described and depicted in the company's delivered output content. Potential clients for the disclosed processes may include marketing divisions of companies of all sizes, content marketing agencies, writer networks, freelancers on content research, planning and creation and other vendors with tools for topic ideation and creation process, that may gain access via, for example, application programming interfaces (APIs).

Exemplary embodiments may be usable to identify most promising new topic opportunities to write about as may be particularly relevant for a company's business and to enhance the company's online presence, including by understanding (a) how many articles the company, and separately its competition, have per topic; (b) how successful already-used topics are and have been over time; (c) how to deal with such topics in the future, and (d) how the performance of the company's own articles have been compared to defined competitors' articles, identifying relevant topic gaps.

As has been discussed throughout this disclosure, conventional methods for researching the web to find topics that seem to match a company's business can be a hit-or-miss proposition for all the reasons outlined above, including working with certain inaccurate or incomplete assumptions. Again, as noted above, employing conventional platforms that offer lists of used search terms related to a given keyword/phrase, and trying to manually cluster them into topics, may yield an incomplete solution, including by “asking” LLMs for topics. The pervasive use of use of legacy analytics platforms that show results URL-wise may provide no relation to the company's business topics.

Employing other platforms that offer lists of used search terms, related to a given keyword/phrase, and trying to manually cluster them into topics, compare rankings, traffic and amount of articles ranking for the client and all competitors by exporting single data and combine them in tables may not provide the needed results to enhance a company's business position vis-à-vis its competitors based on generated output content.

In many instances, legacy vendors may think in keywords in the meaning of search terms instead of topics. These schemes rarely offer any topic understanding at all, which may restrict results in higher expenses, and in filing to be target-oriented or promising. Legacy processes to attempt to understand relevant topics (manually), and an opportunity associated with those topics may be inefficient and incomplete, not to mention very time-consuming. Typically, according to these schemes, users may be provided no ability to discover topics with connected keywords that do not occur yet in, for example, top 50, or other, rankings. Using LLMs here may not be reliable as an LLM may need to be more customer-specific than the current schemes provide in order to offer topics in a hierarchy and to understand, what was used, what works and what does not. An answer of a LLM may always be different, and may be incomplete.

Legacy content development techniques may provide little to no understanding of the status quo of the company in regard to content and its success, leading to time-consuming and challenging manual clustering of URLs into topics to understand what topics are successful, and what topics simply are not. Moreover, significant amounts of inefficient manual work may be required with no ability to understand how many articles exist for a specific topic on the website. With that no ability to work with existing content instead of only producing new content efficiencies may be lost.

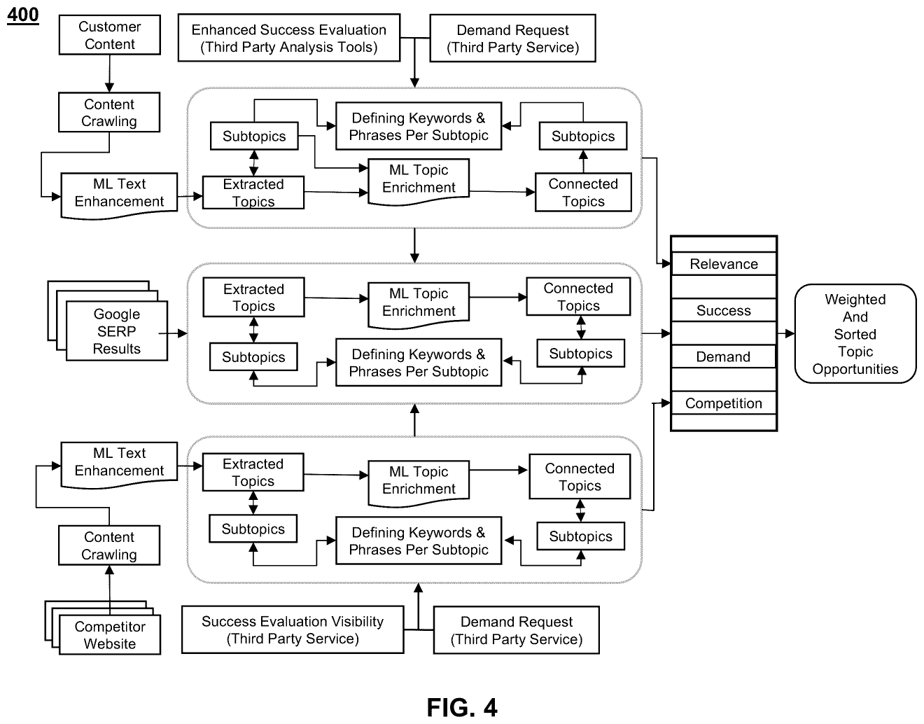

FIG. 4 schematically illustrates a block diagram 400 of an exemplary overview of this process for topic opportunity ideation that may be implemented within an exemplary system for implementing a secure and content-controlled data exchange scheme according to this disclosure.

Exemplary embodiments according to this disclosure may address the shortfalls in legacy systems through unique automated processes for topic ideation and opportunity assessment that may offer customer-specific topic identification. In embodiments, a deep ML-based company-granular topic understanding may enable a user or user enterprise to understand what new topics are connected to the company's business, how much in demand the topics may be, and how good the opportunity may be to reach high visibility in the targeted audience with those topics.

Exemplary embodiments recognize and leverage a contextual importance for a customer's business of the demand for all related, single topics, but also consider in the analysis a recognition of a status quo in regard to success with already used topics, and the competition. Exemplary embodiments may combine relevance, demand, previous success and feasibility as metrics for a success evaluation, all with regard to topics, based on deep ML.

Regarding evaluation of a company's competitors, exemplary embodiments of the disclosed process may crawl the whole websites of the company and the company's competitors to identify which pages are articles and to organize them into topics and subtopics (multiple levels possible, depending on topic size). Embodiments may grab third-party data for rankings, search terms and traffic, and may organize them as well in a table for a detailed overview and for an identification of relevant topic gaps.

Exemplary embodiments may provide identification of articles of a blog or other content hub of a company that need optimization, and of a kind of optimization that may be most appropriate. In embodiments, an opportunity may be provided to import those articles into the platform to implement the recommendations with a supported process inside the platform. This optimization process may also primarily be used in marketing, especially in content marketing, for identifying existing content with a need for optimization with the goal of increasing the above-enumerated and other defined KPIs of a company and the company's output content offerings.

It is recognized that other shortfalls in conventional and/or legacy content delivery processes and systems exist particularly with regard to article optimization. These shortfalls may include, but are not limited to:
Limits on getting a topic-structured existing-article-overview in that especially enterprise companies rarely have an overview about their published content. The enterprise companies often do not know (a) what topics they may have already covered, and (b) whether their articles may be outdated, duplicated or simply badly written.
Limits on understanding article quality which may be based on obtaining only an overview about the general article quality of the existing content.
Limits on a full understanding or identification of content that needs optimization by understanding which articles need optimization.
Limits on the identification of the kind of optimization needed for each affected article.
Limits on understanding task prioritization, e.g., understanding where to start with the optimization to make it most effective.
Limits on an ability to recognize the efficiencies attainable by importing the articles directly into the platform for optimization, as legacy systems may provide no mechanism by which to import the affected articles to a tool to implement the recommendations without, for example, undertaking a tedious process on manual copy-pasting article content.
Limits on platform-supported optimization.

Conventional and legacy schemes are burdened with manual work based on sitemap, categories and search term clustering. The latter is hardly possible for not ranking articles. Burdensome manual effort may also be driven by using tools that check the usage of search terms in an article combined with tools to check the readability and SEO factors or add insights from commercial search strategies and commercial analytics, none of which may provide any possibility to check the article content, including context wise. Using tools that check the usage of search terms in the article and only commercial search strategies and commercial analytics to make decisions based on article performance may provide no ability to get a meaningful comparison and review of all articles, based on content. Identification of the kind of optimization needed in generally reduced to the advice of adding search terms. Conventional and legacy AI-based tools additionally offer limited structural optimization or any capacity for, for example, changing tone. Manually checking the available search volume for most often used search terms for an article renders potentially irrelevant statistical data where usage decisions may be based solely on demand. Manual copy-pasting limits a capacity to optimize directly in any content management system (CMS) or similar tool. Support implemented by conventional and legacy AI-tools limits the overall content and topic focus of the website, which is not taken into account.

Conventional and legacy processes require too much manual effort and are significantly time-consuming with no topic understanding. No ability is provided to obtain a meaningful structured overview, comparison and review of all existing articles. Search terms and their volume should not be the only factor taken into consideration. Relevance of the topic for the company's business should be paramount, e.g., that the optimization of one article will be the missing puzzle piece to cover a whole, very relevant and demanded topic.

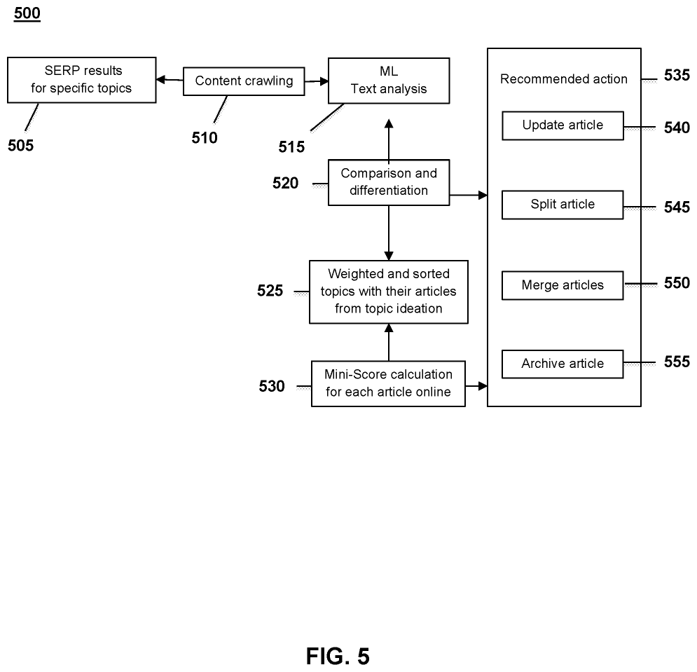

FIG. 5 schematically illustrates a block diagram 500 of an exemplary overview of a process for article optimization that may be implemented within an exemplary system for implementing a secure and content-controlled data exchange scheme according to this disclosure.

As shown in FIG. 5, the platform may obtain a topic-structured existing-article-overview beginning with a step 505 of reviewing and importing search engine results page (SERP) results for one or more specific topics. Based on topic opportunity ideation, an ability may be provided to only show existing articles so as to differentiate between existing articles and articles that are in creation and online. As will be described in some greater detail below, when the platform integrates an optimization part, the SERP crawling (element 505 in FIG. 5) for the customer-specific topics is used to identify top ranking articles for those topics. Crawling those articles in next steps provides documents that can be used (together with all insights from topic evaluation etc.) to evaluate a customer's existing articles. Based on the insights gained, optimization recommendations may be made. Later, embodiments of the platform may import only the customer's article will be imported (technically), with a click, so the customer's article may then be focused on and optimized.

Once the articles are imported for optimization, the platform may crawl the content in all relevant articles in step 510 to analyze all the relevant articles using, for example, ML Text analysis in step 515 with an objective of scoring the articles. The user may choose to optimize an article with a single click, the article content, keeping images, ALT data, META data and structuring.

Based on all data collected via topic opportunity ideation, comparison and differentiation of the articles and topics may be undertaken at step 520. Weighted and sorted topics and their articles may be provided at step 525. A result of this may be to calculate a Mini-Score at step 530 and the ability to compare a customer's article to top ranking articles with the same specific topic. A Mini-Score of every article on the company's website may be based, for example, on readability, and SEO, both technical and content related, to understand and score article quality.

The platform may generate a recommended action at step 535, which may include one or more of a recommendation to update, merge, split and archive articles. This step may fulfill the need for identification of a particular kind of optimization needed.

An optimization to “Update” an article at step 540 may be identified, for example, for articles that: include outdated information, miss links or other SEO related material, or have a less than optimum readability.

An optimization to “Split” an article at step 545 may be identified, for example, for articles where the user could make a series of articles out of a single article, meaning that the article may include too many subtopics (topic ideation) rendering it potentially too complex for a reader to consume, or otherwise too long to offer a good readability for the targeted user group.

An optimization to “Merge” an article at step 545 may be identified, for example, for multiple articles that are contextually very similar to each other, so it would be handled by a search engine as duplicated content such that the recommendation may be to merge the multiple articles into one.

An optimization to “Archive” an article at step 545 may be identified, for example, for articles that do not match with any of the identified relevant topics for the company, or articles that are content-wise completely outdated.

The platform may combine all gained knowledge about relevant topics for the company, the demand for them, the coverage of them on the company website and the performance of all articles in one topic with the strategic focus of the company to deliver a prioritized to-do list for newly to create articles and those that need optimization.

Exemplary embodiments may find value is assigning a score that evaluates the probability of high visibility for an article and that supports a user in optimization.

A content score (R-Score) assigned according to exemplary embodiments may be usable in marketing, especially in content marketing, for creating meaningful content and optimizing content with the goal of increasing defined KPIs of a company and its offerings. This score may provide a heretofore unknown metric for understanding how well-written an article is for a user, rated from the angles of topic relevance, readability and comprehensibility based on a company-defined target group, as well as regarding technical requirements on content, structure and style, and an understanding of what may be done to optimize an article. Assigning such a score may provide a prediction on how successful (in regard to visibility) an article may be.

Assigning such a score may overcome shortfalls in manual reviews offered by other vendors for single criteria of a text that may be considered similar, but inferior, to the R-Score, without contextual reference, and the fact that no real successful prediction methodology may exist. No evaluation of success may take place in conventional solutions because topic reference is largely or completely disregarded in those solutions.

In conventional and legacy evaluation systems, methods or processes, mapping of a topic is considered successful if a predefined statistical number X hits per keyword is achieved. No contextual reference is established. There is no relevance evaluation. This approach is contrary to the NLP technology used by search engines today for evaluating the content of an article. Criteria like readability are calculated regardless of the target group and topic knowledge of the target group.

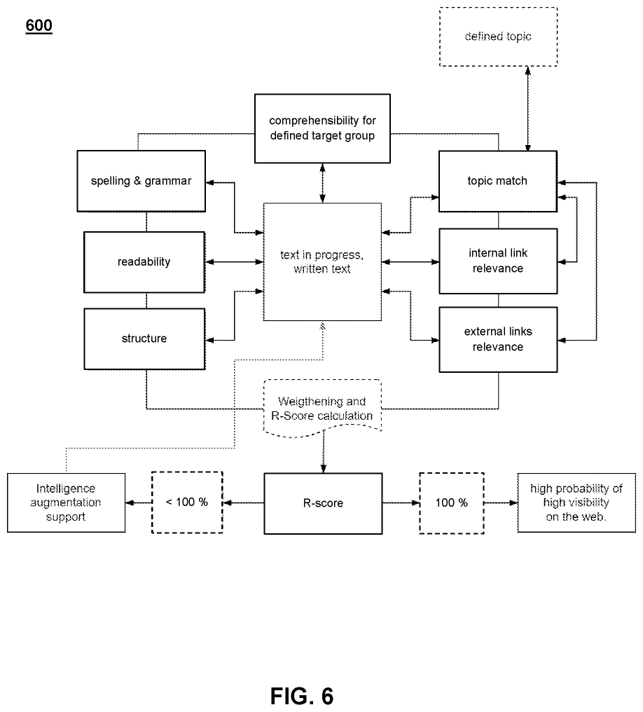

FIG. 6 schematically illustrates a block diagram 600 of elements that may be considered in an exemplary process for assigning a score that evaluates a probability of high visibility for an article and that supports a user in optimization that may be implemented within an exemplary system for implementing a secure and content-controlled data exchange scheme according to this disclosure.

Exemplary embodiments may provide algorithms underpinning a relevance score (R-Score) that may evaluate a text in terms of all criteria that are important for achieving visibility for the company's target group. Topic relevance may have the highest impact on the R-Score. In embodiments, the R-Score may be checked whether everything written, as well as linked contents, have a sufficiently close relation (relevance) to a topic of the text. Integrated intelligence augmentation may support a user in writing meaningful content that may harvest high visibility on the web with concrete advice. In embodiments, the higher the relevance for the target group, the larger the probability of high visibility of the content.

In embodiments, a process of R-score assignment may account for some or all of the elements and their interactions shown in FIG. 6.

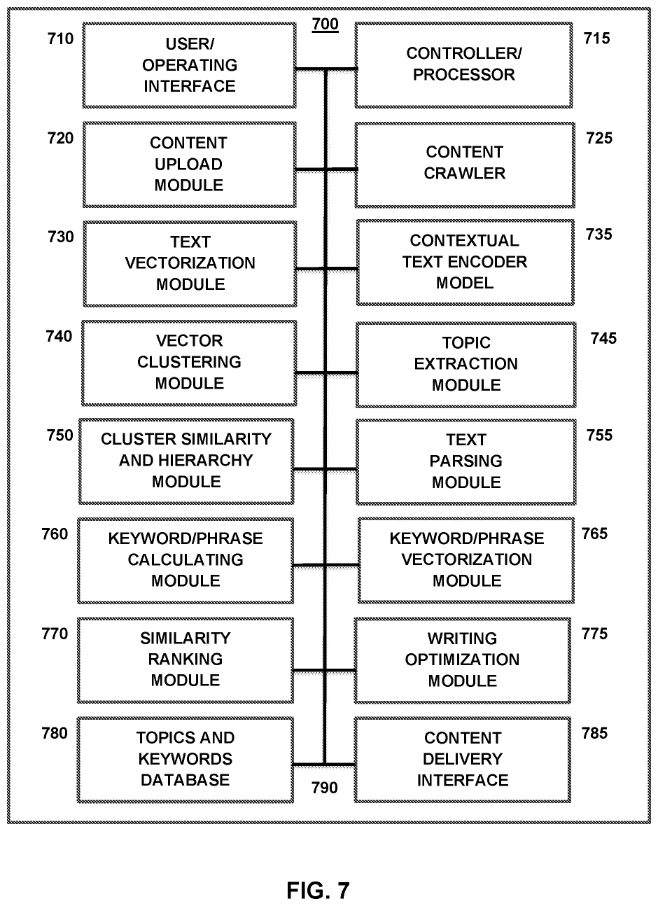

FIG. 7 schematically illustrates a block diagram of an exemplary system 700 for implementing an advanced content search, generation, delivery and data management platform according to this disclosure.

The exemplary system 700 may include a user/operating interface 710 by which a user may communicate with the exemplary system 700. The user/operating interface 710 may provide a user an opportunity to interact with the exemplary system 700 to initiate operation of the platform, and to carry into effect the exemplary schemes, techniques and processes according to this disclosure. The user/operating interface 710 may be configured as one or more conventional mechanisms common to computing and/or communication devices that may permit the user to input information to the exemplary system 700. The user/operating interface 710 may include, for example, a conventional keyboard, a touchscreen with “soft” buttons or with various components for use with a compatible stylus, a microphone by which the user may provide oral commands to the exemplary system to be “translated” by a voice recognition program, or other like device by which a user may communicate specific operating instructions to the exemplary system 700.

The exemplary system 700 may include one or more controllers/processors 715 for interconnecting the various components or modules of the exemplary system 700, and/or for controlling operation of the various components or modules of the exemplary system 700 to carry into effect the disclosed methods, schemes, techniques and processes. The controller/processor 715 may carry out routines appropriate to operation of the exemplary system 700, and may undertake data manipulation and analysis functions appropriate to uploaded content and producing output content in the manner generally depicted and described above. The controller/processor 715 may include at least one conventional processor or microprocessor that interprets and executes instructions to direct specific functioning of the exemplary system 700, and control of the automated implementations of the advanced content search, generation, delivery and data management platform according to this disclosure.

The exemplary system 700 may include a content upload module 720 that may be in a form of one or more data storage devices. Such a content upload module 720 may provide a storehouse for user content and/or competitor content in the manner described above.

The content upload module 720, and other data storage device(s) disclosed as potentially being parts of, or associated with, the disclosed platform, may include a random access memory (RAM) or another type of dynamic storage device that is capable of storing updatable database information, and for separately storing instructions for execution of system operations by, for example, controller(s)/processor(s) 715. Data storage device(s) contemplated by this disclosure may also include a read-only memory (ROM), which may include a conventional ROM device or another type of static storage device that stores static information and instructions. Further, any disclosed data storage device(s), including the content upload module 720, may be integral to the exemplary system 700, or may be provided external to, and in wired or wireless communication with, the exemplary system 700, including as cloud-based (or other virtual) data storage components.

The exemplary system 700 may include one or more of: a content crawler 725; a text vectorization module 730; a contextual text encoder module 735; a vector clustering module 740; a topic extraction module 745; a cluster similarity and hierarchy module 750; a text parsing module 755; a keyword or key phrase calculating module 760; a keyword or key phrase vectorization module 765, a similarity ranking module 770; a writing optimization module 775; a topics and keywords database 780; and a content delivery interface 785. Each of the enumerated modules and/or components may be provided in the exemplary system 700 to carry into effect the individual functions of the exemplary methods, schemes, techniques and processes described in detail above.

Any or all of the various components of the exemplary system 700, as depicted in FIG. 7, may be connected internally, and to one or more external components by one or more data/control busses 790. These data/control busses 790 may provide wired or wireless communication between the various components of the exemplary system 700, whether all of the components of the exemplary system 700 are housed integrally in, or are otherwise external and connected to, the exemplary system 700.

It should be appreciated further that, although depicted in FIG. 7 as an essentially integral unit, the various disclosed elements of the exemplary system 700 may be arranged in any combination of sub-systems as individual components or combinations of components, integral to a single unit, or external to, and in wired or wireless communication with the single unit of the exemplary system 700. Wireless communications may be by RF radio devices, optical interfaces, NFC devices and other wireless communicating devices according to RF, Wi-Fi, WiGig and other like communications protocols. Separately, the various disclosed elements of the exemplary system 700 may be in a form of physical or virtual components in any combination. In other words, no specific configuration as an integral unit, as a support unit, as a physical unit or as a virtual unit, completely or in parts, is to be implied by the depiction in FIG. 7.

Further, although depicted as individual units for ease of understanding of the details provided in this disclosure regarding the exemplary system 700, it should be understood that the described functions of any of the individually depicted components may be undertaken, for example, by one or more controllers/processors 715 connected to, and in communication with, one or more data storage device(s).

The disclosed embodiments may include a non-transitory computer-readable medium storing instructions which, when executed by a processor may cause the processor to execute all, or at least some, of the steps of the methods outlined above.

Although depicted and described in differing particular sequences above, it should be noted that the disclosed steps of any method steps are not limited in any order as may be implied by the descriptions above. The steps of the exemplary disclosed method, schemes, techniques and processes may be, for example, executed in any manner limited only where the execution of any particular method step provides a necessary pre-condition to the execution of any other method step.

Although the above description may contain specific details as to one or more of the overall objectives of the disclosed schemes, and exemplary overviews of systems and methods for carrying into effect those objectives, these details should be considered as illustrative only, and not construed as limiting the disclosure in any way. Other configurations of the described embodiments may properly be considered to be part of the scope of the disclosed embodiments.

For example, the principles of the disclosed embodiments may be targeted uniquely to the needs of each individual user or user enterprise without affecting the application to other individual users or user enterprises where each user or user enterprise may individually access features of the disclosed solutions, as needed, according to one or more of the multiply discussed exemplary embodiments and/or configurations. This enables each user or user enterprise to make full use of the benefits of the disclosed embodiments even if any one of a large number of possible applications does not need all of the described functionality. In other words, there may be multiple instances of the disclosed systems, methods, schemes, techniques and processes each being separately employed in various possible ways at the same time where the actions of one user or user enterprise do not affect the actions of other users or user enterprises using separate and discrete embodiments.

Other configurations of the described embodiments of the disclosed systems, methods, schemes, techniques and processes are, therefore, part of the scope of this disclosure. It will be appreciated that various of the above-disclosed and other features and functions, or alternatives thereof, may be desirably combined into many other different systems or applications. Also, various alternatives, modifications, variations or improvements therein may be subsequently made by those skilled in the art which are also intended to be encompassed by the following claims.

We claim:

1. A system for implementing a content-intelligence platform, comprising:
a first data storage device storing a corpus of data for an enterprise;
a processing device that is configured to:
perform a text vectorization on the corpus of data;
cluster text vectors for the corpus of data;
extract topics from the clustered text vectors;
cluster the extracted topics according to a similarity;
store clusters of the extracted topics in a second data storage device;
parse text from the corpus of data;
calculate key words and key phrases;
perform a vectorization of the key words and key phrases;
apply a similarity ranking to the vectorization of the key words and key phrases
store results of the similarity ranking in the second data storage device; and
output selected topics, key words and key phrases as content intelligence for content delivery for the enterprise.

2. A method for implementing a content-intelligence platform, comprising:
storing a corpus of data for an enterprise in a first data storage device;
performing a text vectorization on the corpus of data;
clustering text vectors for the corpus of data;
extracting topics from the clustered text vectors;
clustering the extracted topics according to a similarity;
storing clusters of the extracted topics in a second data storage device;
parsing text from the corpus of data;
calculating key words and key phrases;
performing a vectorization of the key words and key phrases;
applying a similarity ranking to the vectorization of the key words and key phrases
storing results of the similarity ranking in the second data storage device; and
outputting selected topics, key words and key phrases as content intelligence for content delivery for the enterprise.
